(19) United States
(12) Patent Application Publication
(10) Pub. No.: US 2007/0299953 A1
(43) Pub. Date: Dec. 27, 2007

(54) Centralized work distribution management

(75) Inventors: Jackie E. Walker, Charlotte, NC (US); Aaron D. Harrell, Charlotte, NC (US); Felix Ammay, Kings Mountain, NC (US); David K. Hannon, Charlotte, NC (US); Jair T. Britto, Frunklin, TN (US); Kathleen Howell, Mooresville, NC (US); Kathryn W. Childs, Conoord, NC (US); Jeffrey C. Lee, Gaffney, SC (US); Nathaniel Meyer, Charlotte, NC (US); Joel Daniel Morris, Stanley, NC (US)

Correspondence Address: MERCHANT & GOULD BELLSOUTH CORPORATION, P.O. BOX 2903, MINNEAPOLIS, MN, 55402, US

(73) Assignee: BellSouth Intellectual Property Corporation

(21) Appl. No.: 11/474,839

(22) Filed: Jun. 26, 2006

(51) Int. Cl. G06F 15/173

(52) U.S. Cl. 709/223

(57) ABSTRACT

Distribution of network maintenance tasks is managed in a centralized manner. Information associated with components of a communication network, such as status, malfunctions, technical specifications, and the like, is collected from various data sources and tickets for repair or maintenance tasks are made available to technicians in a centralized list. Tickets are categorized in the list, which may be filtered based on individual technicians' credentials. Tasks accepted by technicians are blocked until they are completed or returned to the system. Feedback associated with progress of task completion is received from the assigned technicians. Managers are enabled to monitor and modify assignment of tasks. Updated information relating to network status and/or maintenance operations may be provided to relevant databases.

### TECHNICAL FIELD

Embodiments are related to managing network maintenance tasks. More particularly, the disclosed subject matter is related to computer-implemented methods, configurations, systems, and computer program products for facilitating centralized distribution of communication network maintenance tasks.

### BACKGROUND

Modern telecommunication networks are diverse structures varying in size and complexity. Networks may vary from dedicated, relatively uniform cells to large and complicated systems that may extend over thousands of miles and include a variety of equipment. Maintaining such networks can present a formidable challenge, especially when they are sizeable and include subnetworks consisting of different types of components.

Information such as operational status, technical specifications, and the like, may be maintained by different entities in local or remote data stores. In a typical network maintenance scenario, technicians tasked with repairing malfunctions and performing routine maintenance work may receive instructions manually prepared by administrators who access the data stores individually and prepare prioritized task lists. Considering a variety of problems that may be encountered (ranging from power outages to component failures), geographies and other conditions associated with the networks, and skill sets of technicians, manual management of network maintenance can be inefficient and costly.

### SUMMARY

Consistent with embodiments described herein, systems and methods are disclosed for centrally managing distribution of tasks associated with maintenance of a communication network. Key features or essential features of the claimed subject matter are not necessarily identified in this summary portion.

Embodiments are directed to distribution and management of network maintenance tasks in a centralized manner. A variety of information associated with status, malfunctions, technical specifications, and the like, of components of a communication network may be collected from various databases and tickets associated with repair or maintenance tasks made available to technicians. According to one embodiment, the tickets may be categorized and filtered based on an individual technician's credentials. Tickets accepted by technicians may be blocked until they are completed or returned to the system. Feedback associated with a progress of an assigned ticket may be received from the assigned technician. Additional data such as job performance data may also be collected. Managers may be enabled to monitor and modify assignment of tickets. Updated information relating to network status may be provided to relevant databases.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

FIG. 1 is a block diagram of an example computing operating environment;

FIG. 2 illustrates a networked system where example embodiments may be implemented;

FIG. 3 illustrates a conceptual diagram of main components of centralized work distribution system;

FIG. 4 illustrates an example architecture and interactions between components of a centralized work distribution system according to embodiments;

FIG. 5 illustrates a conceptual diagram of how a centralized work distribution system operates according to an example scenario; and

FIG. 6 illustrates a logic flow diagram for a process of centrally managing distribution of network maintenance tasks according to one embodiment.

### DETAILED DESCRIPTION

As briefly described above, a centralized network maintenance work distribution system may be provided for efficient performance of maintenance and repair tasks. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

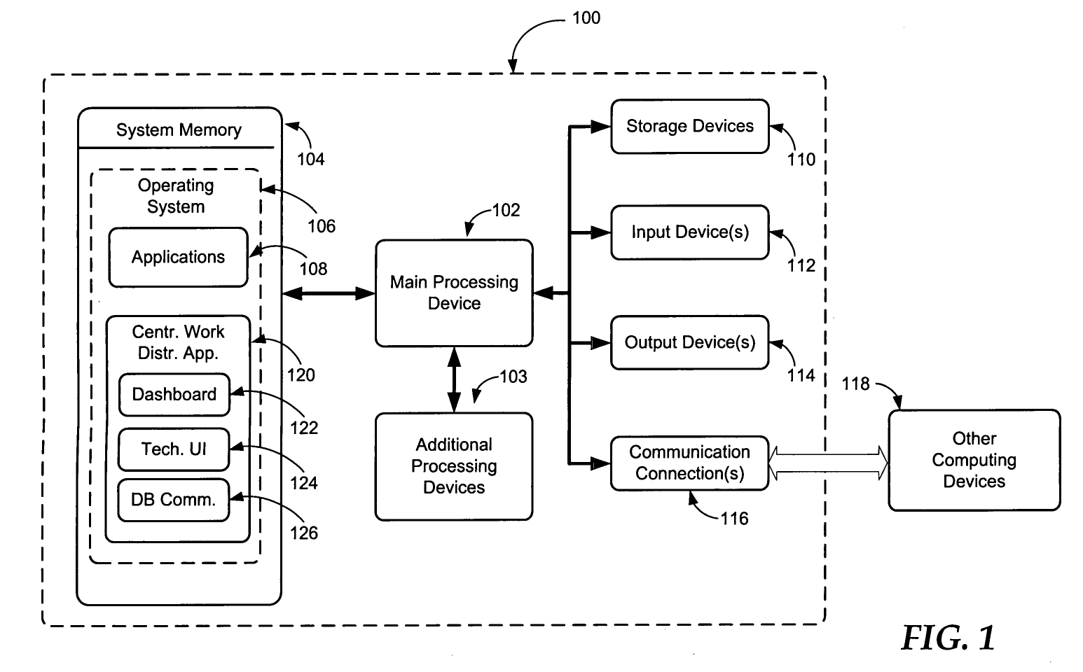

Referring now to the drawings, aspects and an exemplary operating environment will be described. FIG. 1 and the following discussion are intended to provide a brief, general description of a suitable computing environment in which the invention may be implemented. While the embodiments will be described in the general context of program modules that execute in conjunction with an application program that runs on an operating system on a personal computer, those skilled in the art will recognize that aspects may also be implemented in combination with other program modules.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

With reference to FIG. 1, one example system for implementing the embodiments includes a computing device, such as computing device 100. Computing device 100 typically includes a main processing device 102 and system memory 104. Computing device 100 may also include additional processing device(s) 103, which may be dedicated processors or enable distributed processing by coordinating with main processing device 102. The system memory 104 may be volatile (such as RAM), non-volatile (such as ROM, flash memory, etc.) or some combination of the two. System memory 104 typically provides an environment for an operating system 106 to be executed for controlling the operation of computing device 100 and execution of other programs (applications). Software applications 108 and centralized work distribution application 120 are examples of programs or program modules that may be executed under the control of operating system 106 in system memory 104. Additional operating systems or programs may also be executed within system memory 104 outside the control of operating system 106. Centralized work distribution application 120 may coordinate distribution and monitoring of maintenance and repair tasks associated with a communication network.

According to some embodiments, centralized work distribution application 120 may include one or more modules responsible to individual operations in managing network maintenance tasks. The modules may include manager's dashboard 122 configured to enable managers to monitor, assign, modify, and remove tasks; technician's user interface (UI) 124 configured to enable technicians to view an available task list, accepts tasks, and provide feedback; and database communication module 126 configured to receive information associated with the tasks from various network databases, provide updates to selected network databases, and provide collected data to other databases. Individual modules may be an integrated part of a centralized work distribution application 120 or a separate application. The modules and centralized work distribution application 120 may communicate with other applications running on computing device 100 or on other devices. Furthermore, centralized work distribution application 120 may be executed in an operating system other than operating system 106.

The computing device 100 may have additional features or functionality. For example, the computing device 100 may also include data storage devices 110 (removable and/or non-removable) such as, for example, magnetic disks, optical disks, or tape. Computer storage media may include volatile and nonvolatile, removable and non-removable media implemented in any method or technology for storage of information, such as computer readable instructions, data structures, program modules, or other data. System memory 104 and storage devices 110 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100.

Computing device 100 may also include input device(s) 112 such as a keyboard, a mouse, a pen, a voice input device, a touch input device, etc. Furthermore, output device(s) 114 such as a display, a speaker, a printer, etc. may also be included. These devices are well known in the art.

Communication connections 116 may be included in computing device 100 to allow the device to communicate with other computing devices 118, such as over a network in a distributed computing environment, for example, an intranet or the Internet. Communication connections 116 exemplify various communication media. Communication media may be embodied by computer readable instructions, data structures, program modules, or other data in a modulated data signal, such as a carrier wave or other transport mechanism, and include any information delivery media.

By way of example, and not limitation, communication media may include wired media such as a wired network or direct-wired connection, and wireless media such as acoustic, RF, infrared and other wireless media. The term computer readable media as used herein refers to both storage media and communication media.

Typical components of a computing device where embodiments may be implemented are shown in FIG. 1. The implementation of embodiments is, however, not limited to computing device 100. Other computing devices with different components, configurations, and the like, may be used to execute computer readable instructions implementing embodiments described herein without departing from a scope and spirit of the claimed subject matter.

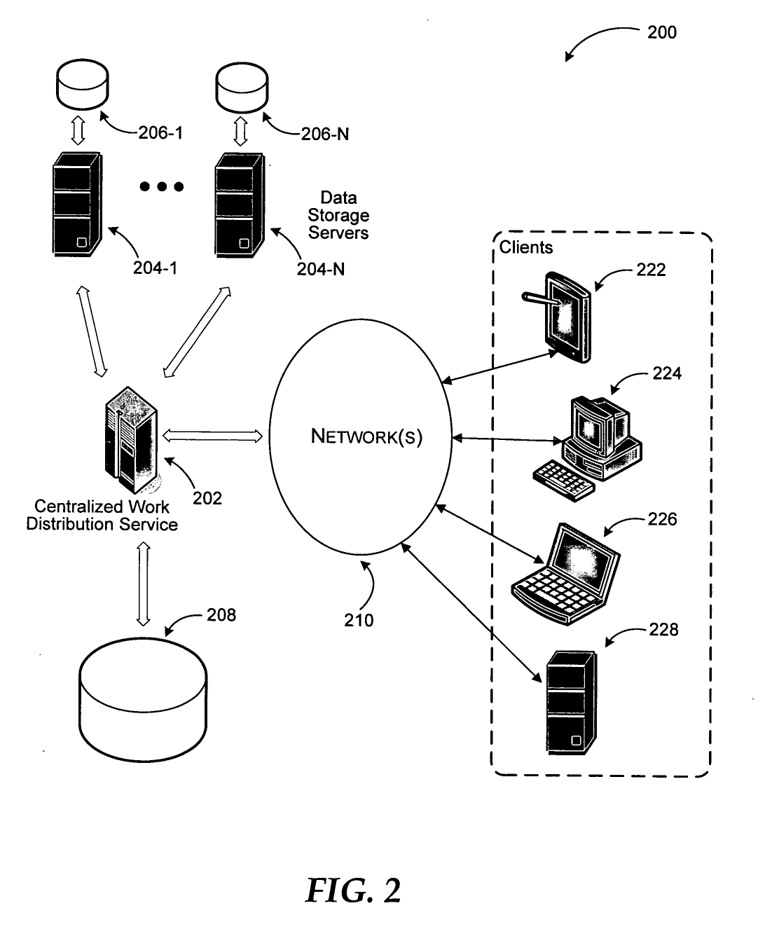

Referring to FIG. 2, a networked system 200 where example embodiments may be implemented, is illustrated. System 200 may comprise any topology of servers, clients, Internet service providers, and communication media. Also, system 200 may have a static or dynamic topology. The term “client” may refer to a client application or a client device employed by a user to perform business logic operations. Centralize work distribution service 202 may be one or more programs or a server machine executing programs associated with the server tasks. Both clients and application servers may be embodied as single device (or program) or a number of devices (programs). Similarly, data sources may include one or more data stores, input devices, and the like.

The centralized work distribution application 120 may be run centrally on centralized work distribution service 202 or in a distributed manner over several servers and/or client devices. Centralized work distribution service 202 may include implementation of a number of task management systems such as activity tracking, performance evaluation, activity scheduling, and the like. A number of other applications may also be configured, deployed, and shared in system 200. In addition, the centralized work distribution application 120 may also be run in one or more client devices and information exchanged over network(s) 210.

Data stores 206-1 through 206-N are examples of a number of data stores that may be utilized to store data associated with the network that is being maintained. Data stores 206-1 through 206-N may be managed by data storage servers 204-1 through 204-N or directly accessed by centralized work distribution service 202 or any one of the clients. Centralized work distribution service 202 may receive information associated with the network from data stores 206-1 through 206-N and store in a central data store 208.

Users such as technicians, managers of various levels, and administrators may interact with centralized work distribution service 202 running the network maintenance management application from client devices 222, 224, 226, and 228 over network(s) 210. In one embodiment, portions or all of the centralized work distribution application 120 may reside on any one of the client devices 222, 224, 226, and 228. In such an embodiment, data may be stored in data stores 206-1 through 206-N without an involvement of centralized work distribution service 202.

According to some embodiments, users may be provided one or more user interfaces (UIs) to interact with the centralized work distribution application 120. Technicians may view and accepts tasks from a list of available tasks (e.g. open ticket list). Other users, such as managers, may monitor task distribution activity, assign and redirect tasks, and the like.

Network(s) 210 may include a secure network such as an enterprise network, or an unsecure network such as a wireless open network. Network(s) 210 provide communication between the nodes described above. By way of example, and not limitation, network(s) 210 may include wired media such as a wired network or direct-wired connection, and wireless media such as acoustic, RF, infrared and other wireless media. Many other configurations of computing devices, applications, and data storage may be employed to implement a centralized work distribution system.

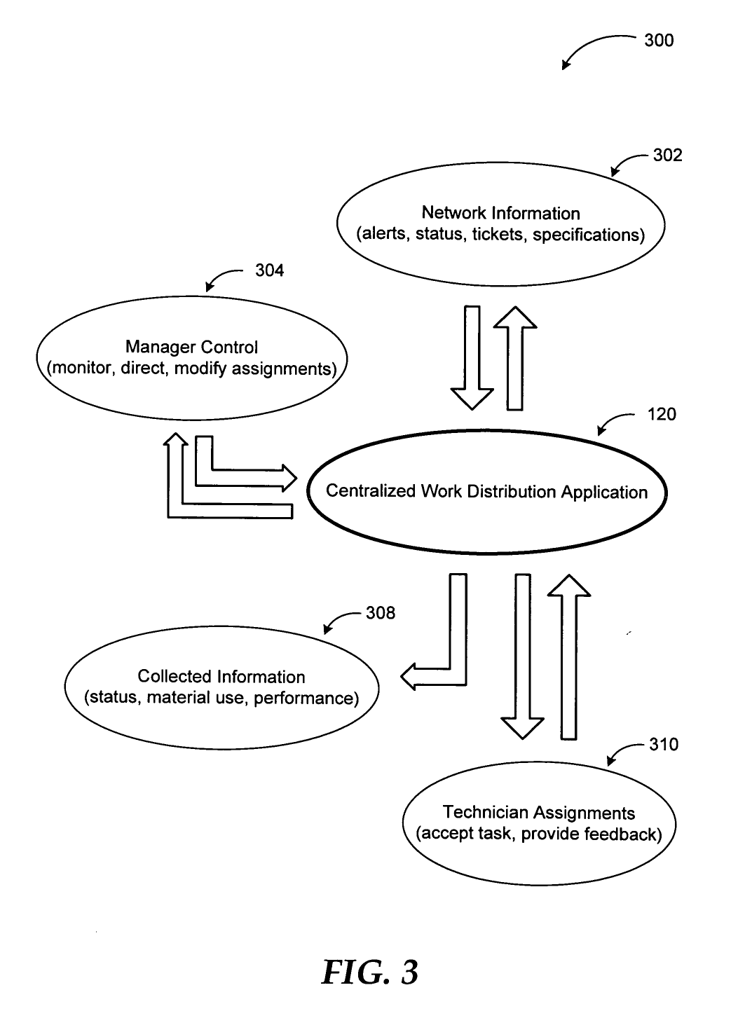

Now referring to FIG. 3, conceptual diagram 300 of main components of the centralized work distribution service 202 is illustrated. The centralized work distribution service 202 according to embodiments may be implemented in any topology of processing systems, storage systems, source systems, and configuration systems.

At the core of the centralized work distribution service 202 is centralized work distribution application 120, which receives input associated with network alerts, status, open tickets, malfunction locations, technical specifications, and the like, from network information sources 302. Network information sources 302 may be implemented as discrete or integrated databases, applications, web servers, and the like. Based on predetermined parameters, such as time and duration of malfunction, priority status of malfunctioning network component, availability of technicians and/or materials, and the like, open tickets are categorized and prioritized by centralized work distribution application 120.

Categorized open tickets are then made available to technicians in technician assignments component 310. Technicians may view the list through a web application UI or other methods. Technicians may accept tickets from the list, provide feedback on the progress of work, report completion, or input additional information interacting with centralized work distribution application 120.

Manager control component 304 enables interaction of managers with the system, allowing them to monitor open ticket list, progress of work by dispatched technicians, assign or reassign tickets, change or remove tickets, and so on.

Collected Information component 308 may collect data in addition to the network related data provided by network information component 302. Such data may include technician activity tracking data, used materials data, or network status update from the technicians. Collected Information component 308 may provide the collected additional data to other services such as an inventory control service, an activity scheduling service, a performance evaluation service, and the like.

The architecture described in FIG. 3 is for illustration purposes only and does not constitute a limitation on embodiments. Other configurations of a centralized work distribution system may be implemented without departing from a scope and spirit of the present invention.

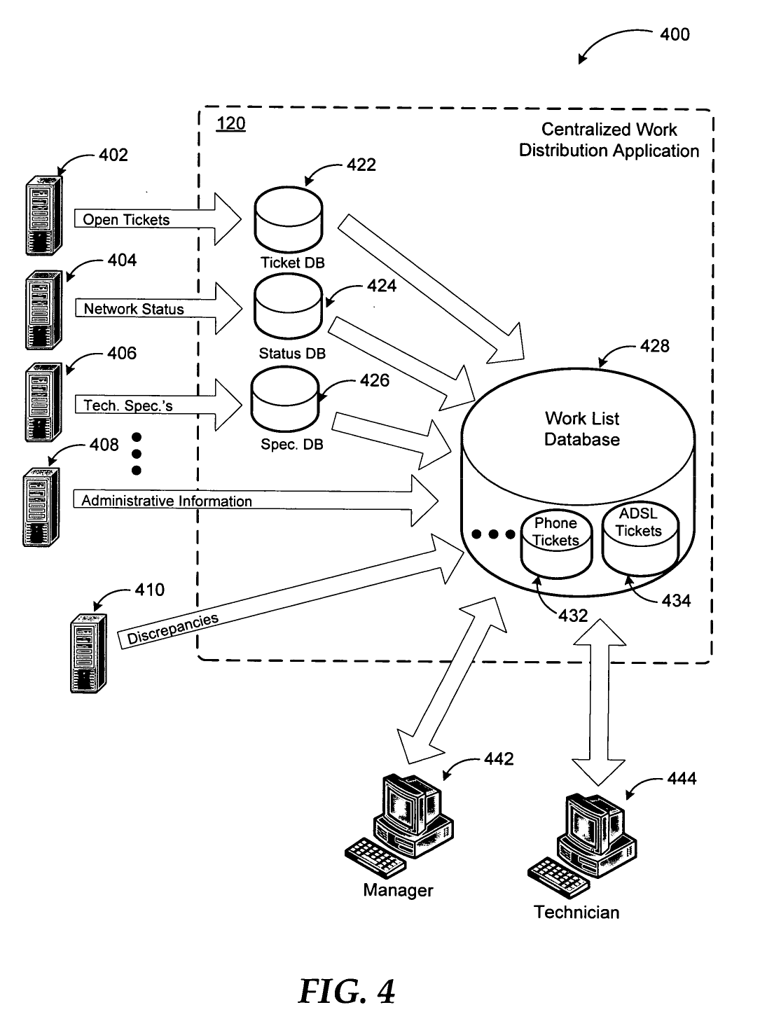

FIG. 4 illustrates example architecture 400 and interactions between components of centralized work distribution application 120 according to embodiments.

Servers 402, 404, 406, 408, and 410 represent a number of sources that may provide information associated with a network that is being maintained. For example, server 402 may provide open ticket data, server 404 may provide network status data, server 406 may provide technical specification data for network components, server 408 may provide administrative information, and server 410 may provide discrepancy information. Servers 402, 404, 406, 408, and 410 may be actual computing devices, applications, or distributed systems. Some of the servers e.g. 402, 404, and 406 may provide the information to data stores ticket database 422, status database 424, and specification database 426, while others e.g. 408 and 410 may provide the information directly to centralized work distribution application 120.

The centralized work distribution application 120 is configured to operate in coordination with multiple data stores, servers, and clients. It coordinates collection of network data from individual data stores to a central data store, such as work list database 428. The centralized work distribution application 120 may facilitate categorization of network maintenance and repair tasks based on the received information e.g. extent of outage, parts availability, duration of outage, priority status of out-of-service customers, and the like. Work list database 428 may include a number of sub-databases or tables based on the categories of open tickets. The grouping may be based on a type of ticket or priority of tasks. For example, the sub-databases may include phone tickets 432, ADSL tickets database 434, and the like, in a mixed telecommunication network.

The centralized work distribution application 120 may also facilitate interaction of technicians (444) and managers (442) with the system by providing user interfaces. Technicians may view open ticket list, accept one or more tickets, receive detailed information associated with the tasks, or provide feedback associated with the tasks (e.g. work progress, materials used/needed, completion, actual duration of task completion). Managers may view status of tasks, assign them to technicians, modify the tasks, or redirect the already assigned tasks. In facilitating the interaction of the technicians and the managers with the system, centralized work distribution application 120 may implement credential based filtering restricting access to information or directing tasks based on credentials of the technicians or managers.

Moreover, centralized work distribution application 120 may collect additional information associated with the performance of the tasks such as used material, technician throughput, and the like, and provide the collected information to other applications e.g. an ERP application, a performance evaluation application, and the like. According to other embodiments, centralized work distribution application 120 may provide updated information to some of the network databases such as status database 424.

The centralized work distribution application 120 may be any application such as an executable computer program, a web application, and the like. The examples provided above are for illustration purposes only. Individual components of a centralized work distribution system may be implemented in any way using the principles described herein including additional components such as databases, user interfaces, and the like. Furthermore, the centralized work distribution application 120 may perform additional operations associated with managing the maintenance of a telecommunications network.

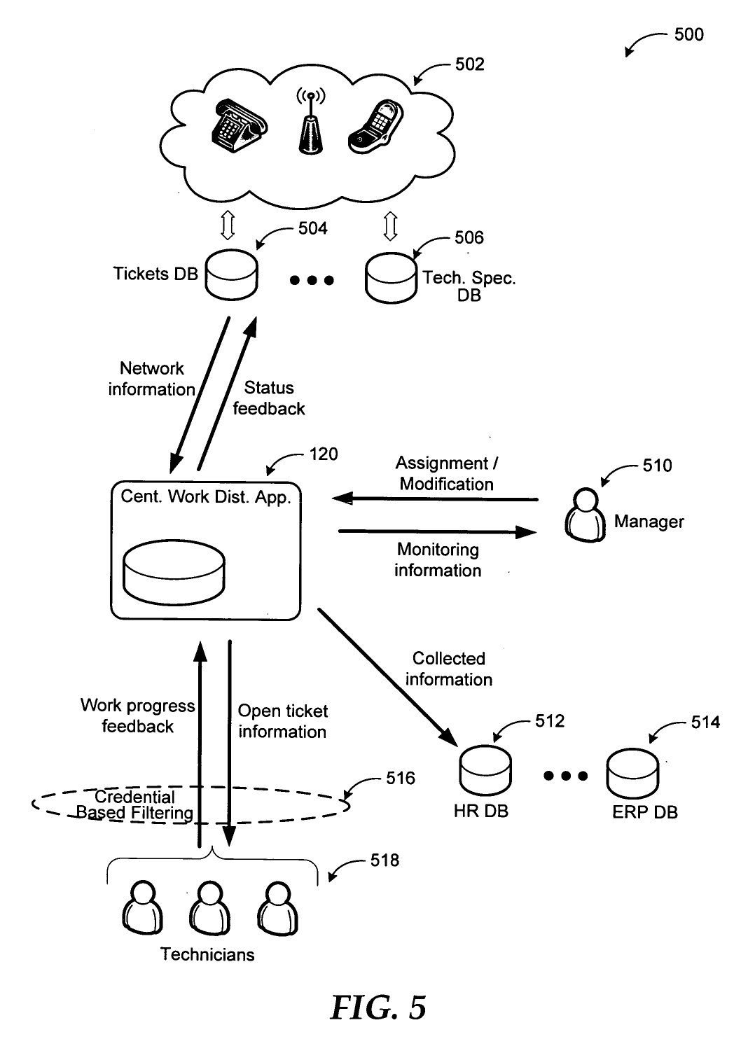

FIG. 5 illustrates conceptual diagram 500 of how the centralized work distribution application 120 operates according to an example scenario. The example scenario is centered around repair and maintenance of telecommunications network 502. Telecommunications network 502 may include various wired and wireless components for phone, data, and other types of communications. Because equipment involved in the infrastructure of such a network is typically very diverse and the network can expand over a large geography, service workforce may include technicians with different skill sets.

According to the example scenario, components of telecommunications network 502 are monitored and any malfunction detected by sensors. Detected malfunctions may be forwarded to a tickets database 504 to be addressed by the service workforce. In addition to detected malfunctions, regularly scheduled maintenance tasks may also be stored in tickets database 504 or another data store. Other databases, such as technical specifications database 506 that includes technical information associated with the network components, may be utilized to provide information about the network to the service workforce.

According to some embodiments, centralized work distribution application 120 may be utilized for efficient use of the service workforce and dispatching of technicians to open tickets. The centralized work distribution application 120 may receive information from the network associated databases or other direct sources (not shown) and prepare a categorized open ticket list. The categorization may be based on a number of factors including, but not limited to, a time and duration of the malfunction, a geography of the malfunctioning network component, available technicians, available materials, priority status of customers serviced by the malfunctioning component, and the like.

The centralized open ticket list is then made available to technicians 518. Technicians 518 may view the list through a web application UI or any other interface tool, and select tickets they would like to work on. Once a ticket is assigned to a technician, it may be blocked to other technicians to prevent duplication of work. The assigned technician may be enabled to receive additional information associated with the ticket such as technical specifications, material lists, etc., through the same UI (e.g. by activating a hyperlink associate with the ticket).

According to other embodiments, the centralized work distribution application 120 may implement a credential based filter 516 to optimize distribution of work or improve security. Different categories of tickets may be made available to technicians with matching skill sets and not to the entire service workforce. For example, tickets associated with sensitive portions of the network may only be made available to technicians with sufficient permission levels and experience.

Upon being assigned by selecting the ticket themselves or receiving the assignment from a manager, the technicians, may provide feedback to centralized work distribution application 120 through the same or another UI. According to another example, centralized work distribution application 120 may be a web application accessible to technicians from any client device by logging in. Once at the work site, the technician may log in to the centralized work distribution application 120 and enter information associated with the progress of work, materials used, or even open a new ticket.

In addition to the technician provided information, centralized work distribution application 120 may collect additional information through monitoring technician activities such as time on the job, time to complete a task, travel time, and the like. Information collected from the technicians and through monitoring may be provided to other applications or databases e.g. human resources database 512, and ERP database 514. Furthermore, the centralized open ticket list may be updated based on the technician feedback and updated information provided to network associated databases such as tickets database 504.

Another significant component of the centralized work distribution application 120 is manager interaction. Managers 510 may interact with the application 120 through another UI and monitor status of the open tickets list. The managers may further be enabled to add, remove, or modify tickets and assignments. The centralized work distribution application 120 may be further configured to issue alerts to selected managers in response to predefined conditions. The conditions may be defined in the system or by individual managers. They may include a number of open tickets exceeding a threshold, delays in completion of tickets, delays in technician feedback, and the like. For example, a manager may activate additional technicians if he/she receives an alert about a surge of network outages. Managers' access to the system may also be subject to credential based filtering.

Interaction of technicians and managers with the centralized work distribution application 120 may take many forms. Information associated with tickets and their status may be presented to the technicians and managers as lists, spreadsheets, charts, histograms, diagrams, or combination thereof. The presentations may be provided on-screen, as electronic mail, downloadable files, facsimiles, and the like. In addition, alerts may be provided as electronic mail, voicemail, instant message, and so on.

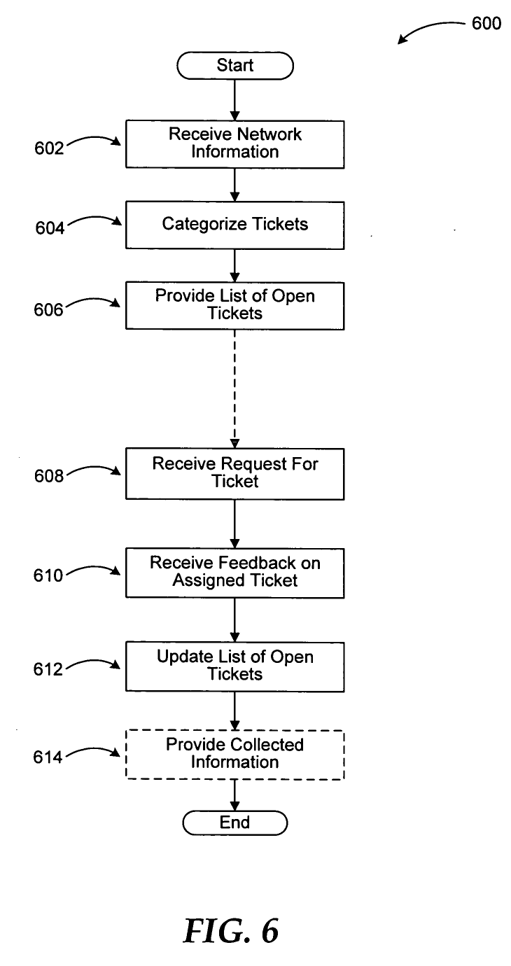

FIG. 6 illustrates a logic flow diagram for a process 600 of centrally managing distribution of network maintenance tasks according to one embodiment. Process 600 may be implemented in centralized work distribution application 120.

Process 600 begins with operation 602, where the centralized work distribution application 120 receives network information from a variety of sources. As described previously, network information may include open tickets, network status, technical specifications, target identifications, location lists, and the like, and come from databases, servers, applications, and other sources. Processing moves from operation 602 to operation 604.

At operation 604, the centralized work distribution application 120 categorizes tickets based on their type, geography, priority, available materials, and so on. A list of open tickets may be prepared from the categorized tickets. The categories may be utilized to filter the open ticket list based on technician credentials. Processing moves from operation 604 to operation 606.

At operation 606, the centralized work distribution application 120 provides open ticket list to technicians and managers. Technicians may select from the list tasks they would like to perform. Managers may review the list, technician assignments, and progress of the maintenance. Managers may also modify or remove tickets on the list, assign or reassign certain tickets.

As illustrated by the dashed progress line, processing within the centralized work distribution application 120 may proceed from operation 606 to operation 608, where the centralized work distribution application 120 receives a request for a ticket from a technician or the ticket assigned to a technician by a manager. Credentials of a technician may be used in determining which tickets can be viewed by individual technicians and assigned to them. Once a ticket is assigned to a technician, the centralized work distribution application 120 may be block the ticket such that duplication of work if avoided. Processing moves from operation 608 to operation 610.

At operation 610, the technician may provide feedback on the assigned ticket to the centralized work distribution application 120. The feedback may include information such as progress, actual duration of the task, used materials, network status update, and the like. As part of the feedback, a technician may also add new ticket(s) to the list of open tickets. Processing advances from operation 610 to operation 612.

At operation 612, the centralized work distribution application 120 updates the list of open tickets. Completed tickets may be removed from the list, new ones may be added. Based on the received information, tickets may also be modified or recategorized. Processing moves from operation 612 to optional operation 614.

At optional operation 614, the centralized work distribution application 120 may provide information collected during the completion of tasks associated with the open tickets to various targets. For example, performance information such as duration of tasks may be provided to a performance evaluation application, used materials information may be provided to an inventory management application. Moreover, updated network status information may be provided to network databases that supplied the original status information. After operation 614, processing moves to a calling process for further actions.

The operations included in process 600 are for illustration purposes. Centrally managing distribution of network maintenance and repair tasks may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for centrally managing network maintenance work distribution, comprising:
receiving a plurality of tasks associated with the network maintenance;
receiving data associated with the plurality of tasks;
categorizing the plurality of tasks based on the data associated with the plurality of tasks;
making the categorized plurality of tasks available to a plurality of technicians;
blocking a task, once the task is selected by a technician of the plurality of technicians; and
receiving feedback associated with a performance of the task from the technician.

2. The method of claim 1, further comprising:
making the categorized plurality of tasks available to a manager for an operation including at least one from a set of: adding a task, removing a task, modifying a task, assigning a task to a technician, and reassigning an already assigned task to another technician; and
executing the manager operation in response to receiving an operation selection from the manager.

3. The method of claim 1, wherein the data associated with the plurality of tasks include at least one from a set of: network status information, malfunction information, location information, target identifier information, and technical specification information; and wherein the data is received from a plurality of databases.

4. The method of claim 3, further comprising:
updating at least a portion of the data associated with the plurality of tasks; and
providing the updated data to at least one of the plurality of databases.

5. The method of claim 1, wherein categorizing the plurality of tasks includes at least one of: grouping the tasks based on a type of malfunctioning network component and prioritizing the tasks based on one of: a time of malfunction, a duration of malfunction, a location of the malfunctioning network component, available materials, and a skill set of available technicians.

6. The method of claim 1, wherein the feedback from the technician includes information associated with at least one from a set of: a progress of task performance, a task performance start time, an estimated duration of task, an actual duration of task, and a used material list.

7. The method of claim 1, further comprising:
providing data to at least one of: a performance evaluation application, an activity scheduling application, and an inventory management application, based on the feedback received from the technician.

8. The method of claim 1, further comprising:
filtering the categorized plurality of tasks before making them available to the plurality of technicians based on a credential of each technician.

9. The method of claim 2, wherein the categorized plurality of tasks is provided to the manager and the plurality of technicians by one of: a user interface, an electronic mail, an instant message, a facsimile, downloadable data, a print-out, and a voicemail.

10. The method of claim 1, further comprising:
issuing an alert to the manager, if a predetermined condition is fulfilled, wherein the predetermined condition is defined by one of a system administrator and the manager.

11. A computer-readable medium having computer executable instructions for automated management of network maintenance work distribution, the instructions comprising:
receiving an open ticket list associated with the network maintenance;
receiving data associated with each of the tickets of the open ticket list from a plurality of databases;
categorizing the open ticket list based on the received data;
making the categorized open ticket list available to a pool of technicians, wherein the list is filtered based on each technician's credentials before being made available;
making the categorized open ticket list available to a manager;
designating a ticket as assigned, once the ticket is selected by a technician of the pool of technicians or assigned to a technician by the manager; and
receiving feedback on a completion of tasks associated with the assigned ticket from the technician.

12. The computer-readable medium of claim 11, wherein the instructions further comprise:
translating the data associated with each of the tickets from the plurality of databases; and
storing the data in a central database.

13. The computer-readable medium of claim 16, wherein the instructions further comprise:
enabling the technician to create a new open ticket.

14. A system for centrally managing work distribution, comprising:
a network maintenance management application arranged to:
receive an open ticket list associated with the network maintenance;
receive data associated with each of the tickets of the open ticket list from a plurality of databases;
categorize the open ticket list based on the received data;
designate a ticket as assigned, once the ticket is selected by a technician or assigned to a technician by a manager; and
a manager user interface (UI) module configured to:
provide the categorized open ticket list to the manager to select among operations including adding a ticket, removing a ticket, modifying a ticket, assigning a ticket to a technician, and reassigning an already assigned ticket to another technician; and
provide the manager's selection to the network maintenance management application; and
a technician UI module configured to:
provide the categorized open ticket list to the technician, wherein the list is filtered based on a credential of the technician before being provided; and
provide the technician's selection to the network maintenance management application.

15. The system of claim 14, wherein the technician UI module is further arranged to provide a feedback from the technician to the network maintenance management application, the feedback including information associated with at least one from a set of: a progress of task performance, a task performance start time, an estimated duration of task, an actual duration of task, and a used material list.

16. The system of claim 15, wherein the network maintenance management application is further arranged to provide updated data to at least one of the plurality of databases based on the feedback from the technician.

17. The system of claim 14, wherein the network maintenance management application is one of a web application, an executable program, and a distributed application.

18. The system of claim 14, wherein the technician UI module is further arranged to provide the technician information associated with the open ticket, once the open ticket is assigned to the technician.

19. The system of claim 14, wherein the credential of the technician includes at least one of a skill set of the technician and a permission level of the technician.

20. The system of claim 14, wherein the network maintenance management application is further arranged to receive data associated with each of the tickets from at least one of an application and a network server.
